(19) United States
(12) Patent Application Publication
(10) Pub. No.: US 2006/0094497 A1
(43) Pub. Date: May 4, 2006

(54) Online gaming interaction protocol ensuring random events

(76) Inventor: Ilya Presman, Brooklyn, NY (US)

Correspondence Address: FAY KAPLUN & MARCIN, LLP, 15O BROADWAY, SUITE 702, NEW YORK, NY, 10038, US

(21) Appl. No.: 10/980,779

(22) Filed: Nov. 3, 2004

(51) Int. Cl. G06F 19/00; G06F 17/00

(52) U.S. Cl. 463/22

(57) ABSTRACT

A method of authenticating a pre-generated random events sequence in an online casino game wherein a user establishes communication with an online casino to request a game session. For each game, there is a certain number and type of estimated random events that will be required to play the game session to completion. The online casino is equipped with a random number generator which pre-generates an estimated number of random events and places the random events into a random events sequence. The random events sequence is coded into an encrypted sequence and then transmitted to the user who stores the encrypted sequence until a game verification stage. During the game session, the user records the random events received from the online casino until the game ends. Also, events from the random sequence are consumed by the online casino during the game session. The online casino sends the user an encryption key to decode the encrypted random events sequence which is compared to the record the user kept of the random events sequence sent by the online casino.

### FIELD OF THE INVENTION

The present invention relates generally to a method for ensuring the authenticity and integrity of online games. More particularly, the present invention relates to a method of using a pre-generated random events sequence to authenticate online casino games.

### BACKGROUND OF THE INVENTION

A major concern for players of online casino games is ensuring the integrity of the online game. Traditionally, casino games have a built-in house advantage which makes it profitable for hosting casinos. The profit the casino makes on games is usually small, therefore, casinos make a profit by servicing many players. It is very tempting for casinos to increase the in-house advantage by tampering with the way “random” events are drawn in a game.

In actual casinos, players are able to verify the integrity of a game by watching the dealer shuffle and deal the cards. Players may, in the case of certain card games, employ certain measures such as cutting the deck to guarantee a random outcome. In the case of online casinos, the player does not have any mechanism to ensure the integrity of the random events in a game. Therefore, the player can not determine whether the random events have been altered by the casino in order to maximize its profits. Typically the online casino includes a random number generator which generates the random events for a particular game. Since the random events are generated during the course of the game, the online casino has access to all the information it needs to alter the sequence of events.

Presently, there is no way for the player to determine whether or not the random events sequence was tampered with to give the online casino an advantage in the game. To address this problem, some electronic game providers give the player the option of reviewing the software code to determine whether the computer fairly generated the random number. However, software code may include thousands of lines of code. Auditing the software code can prove to be a complex and cumbersome task for the player. Other electronic game providers have addressed this problem by providing methods for securing communications between the player and the game server. However, the process of securing communications in games using random numbers does not sufficiently deal with the situation where fraudulent random numbers are transmitted.

The player must be able to determine whether the online casino did not modify the random events sequence in order to take advantage of the player's actions during the game. Therefore, for the reasons stated above, there is currently a need for a protocol between the online casino and the player which ensures and verifies the integrity of the random events sequence and thus, of the game. The present invention overcomes the limitations of the prior art by including a method which utilizes a pre-generated sequence of random events to play an online game.

### OBJECTS AND SUMMARY OF THE INVENTION

It is therefore an object of this invention to provide a means for verifying the integrity and authenticity of a sequence of random events used in an online casino game.

It is another object of this invention to provide a method of using a pre-generated sequence of random events to play an online casino game.

It is a further object of this invention to provide a method of sending a pre-generated sequence of random events to a user in an encrypted and/or digested form so that the user cannot forecast the sequence of random events in the online casino game.

It is yet another object of the invention to provide a method for providing the user with an encryption key and the original random events sequence at the end of a game session to decrypt and verify the pre-generated random events sequence by comparing the stored random events sequence with the original random events sequence and thereby authenticate the random events sequence used in the online casino game.

It is still a further object of this invention to provide a method of sending a pre-generated sequence of random events to a user so that the user may reassemble the random events after a game session is completed.

In accordance with the above objectives, the present invention provides a method of authenticating a pre-generated random events sequence in an online casino game. In a preferred embodiment, a user establishes communication with an online casino to request a game session. The user requests a game to play on the online casino from a list of available games such as blackjack, roulette, craps, etc. Once the user completes the selection of the game, the online casino receives the request and initiates the game session. For each game, there is a certain number and type of estimated random events that will be required to play the game session to completion, or end the game session at the discretion of the user. Each random event represents an action that would occur at a real casino, such as drawing a card or rolling dice. The online casino is equipped with a random number generator which pre-generates an estimated number of random events and places the random events into a random events sequence. The random events sequence is coded into an encrypted sequence and then transmitted to the user who stores the encrypted sequence until a game verification stage. For the step of encoding, the random events sequence may also be converted into a digital digest and transmitted to the user, or first encrypted and then converted into a digital digest and transmitted to the user.

At this stage in the game session, the user cannot interpret the pre-generated encrypted random events sequence the user receives from the online casino, and the online casino does not have to be concerned about the user being able to unfairly forecast the sequence of random events in the future. The user then commences playing the specified game by requesting random events from the online casino. The online casino receives these requests from the user and responds by sending the user the next number drawn sequentially from the pre-generated random events sequence. Events from the random sequence are consumed by the online casino during the game session. The user records all random events received from the online casino. Once the number of random events in the pre-generated sequence have been exhausted or the user indicates an intent to terminate the game session, the online casino communicates a “Game is Over” to the user and the game ends.

The online casino then sends the user an encryption key for game verification to prove the integrity of the game. The encryption key allows the user to decode the encrypted random events sequence that was previously transmitted to the user at the beginning of the game session. The user decodes the encrypted random events sequence and the decoded random events sequence is compared to the record the user kept of the random events sequence sent by the online casino. If the sequences are identical, then the random events sequence was not altered or tampered with by the online casino during the game session. If the random event sequence recorded by the user and the random events sequence presented by the online casino are different, the verification fails. The user then communicates the failure to the online casino and an appropriate action is taken.

The game session may also be played with more than one user. The online casino may send the same encrypted sequence, which is pre-generated, to each participant allowing them to recompile their individual random events sequences into the original pre-generated random events sequences and compare it with the random events sequences sent by the online casino for verification purposes.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a schematic view of a method of authenticating a pre-generated random events sequence in an online casino game, according to the present invention;

FIG. 2 is a schematic view of a method of authenticating a pre-generated random events sequence which is converted into a digital digest, according to the present invention;

FIG. 3 is a schematic view of a method of authenticating a pre-generated random events sequence which is encrypted and converted into a digital digest, according to the present invention; and

FIG. 4 is a schematic view of a method of authenticating a pre-generated random events sequence in a multiple-player game, according to the present invention.

### DETAILED DESCRIPTION OF THE INVENTION

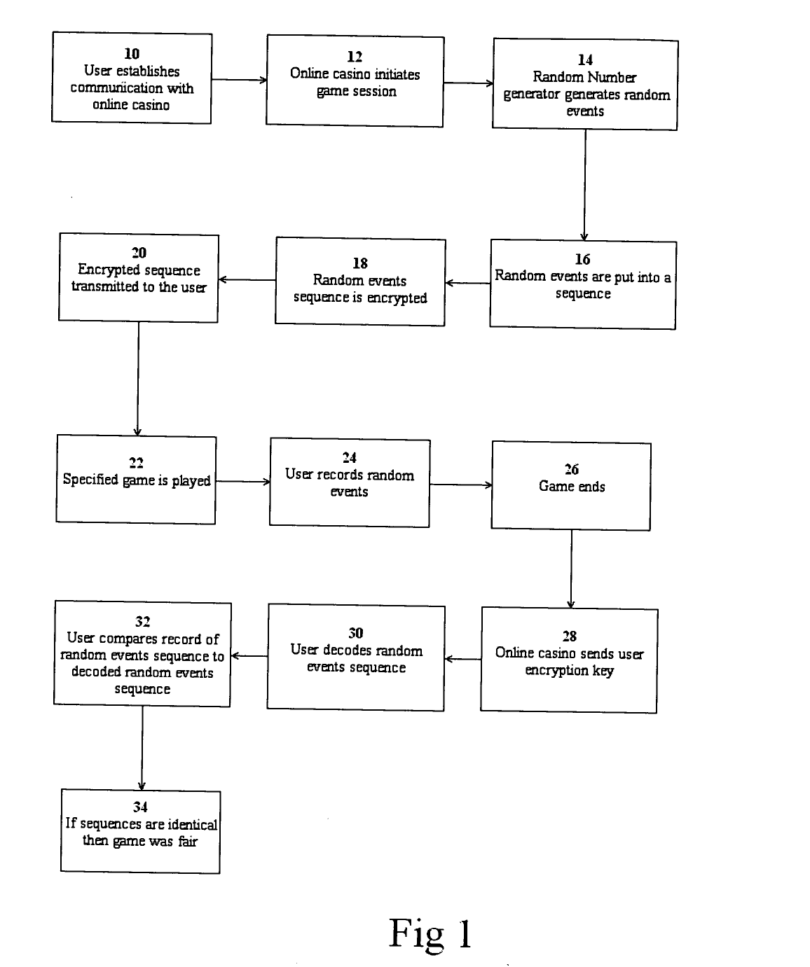

The invention will now be described with reference to FIGS. 1 to 4, which in general discloses a method for ensuring the authenticity and integrity of online games, and more specifically a method of authenticating a pre-generated random events sequence in an online casino game.

Referring to FIG. 1, in a preferred embodiment, a user establishes communication with an online casino 10 to request a game session which is the equivalent of one game in an actual casino. The user possesses the necessary computer, client game software and any other basic materials and hardware needed to establish communication with the online casino. The online casino may be a single computer acting as a game server or several computers where databases and processors are in different locations. The user requests a game to play on the online casino during the game session by selecting from a list of available games. A list of typical games to play during the game session may include one of the following games: blackjack, roulette, craps, baccarat, slot machine, lottery, sports betting and poker. It is understood that the present invention is not limited to these games and may include games not included in the above list.

Once the user completes the selection of the game and communicates the game selected to the online casino, the online casino receives the request and initiates the game session 12. For each game, there is a certain number and type of estimated random events that will be required to play the game session to completion, or end the game session at the discretion of the user. Each random event represents an action that would occur at a real casino, such as drawing a card or rolling dice. For example, in the game of blackjack, the type of random events which occur during the game is the action of drawing cards. The number of random events in one game session will typically not exceed 10,000 events. Events from the random sequence are consumed by the online casino during the game session. The online casino is equipped with a random number generator which pre-generates the random events 14. The random number generator used in the present invention may be any conventional random number generating processor well known in the art.

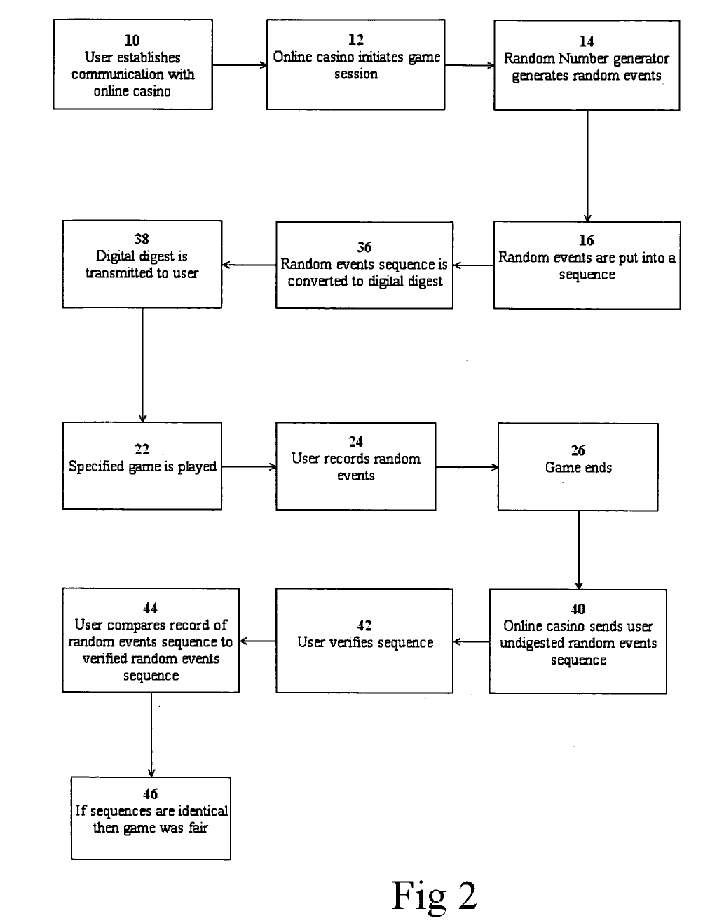

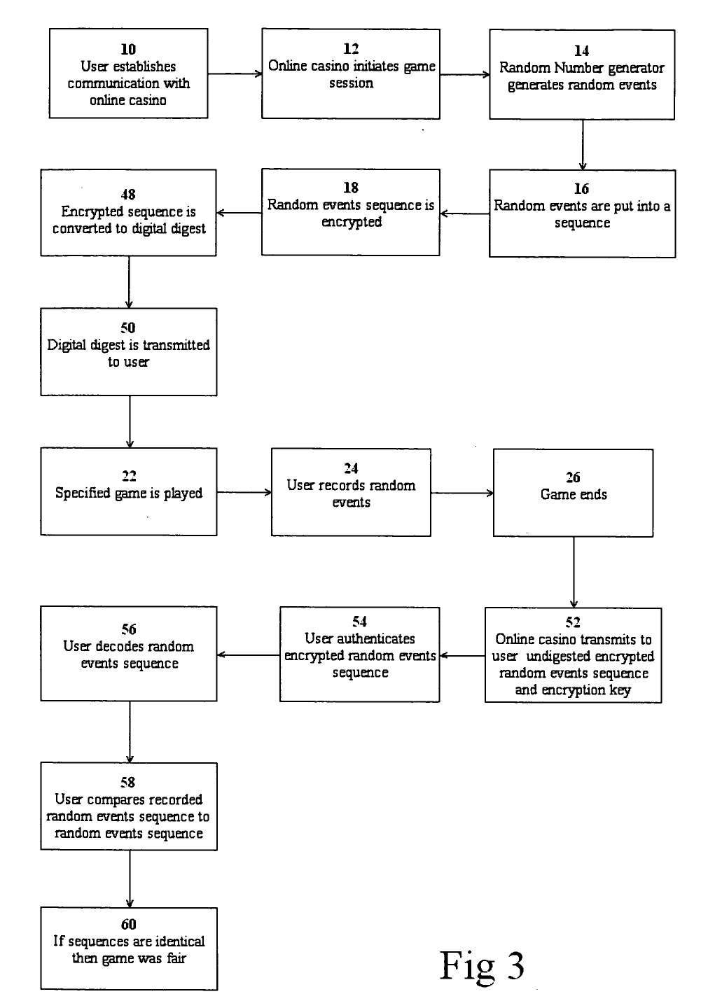

The online casino generates an estimated number of random events and places the random events into a random events sequence 16 which is a set of random events generated for the game session. The random events sequence is coded into an encrypted sequence 18 and then transmitted to the user 20 who stores the encrypted sequence until a game verification stage. The method used to encrypt the random events sequence may be any well known encryption method used in the art. As shown in FIGS. 2 and 3, respectively, for the step of encoding, the random events sequence may also be converted into a digital digest and transmitted to the user, or first encrypted and then converted into a digital digest and transmitted to the user, as described below.

Referring again to FIG. 1, at this stage in the game session, the user cannot interpret the pre-generated encrypted sequence and the online casino does not have to be concerned about the user unfairly predicting the sequence of random events in the future. The user then commences playing the specified game 22 by requesting random events from the online casino. The online casino receives these requests from the user and responds by sending the user the next number drawn sequentially from the pre-generated random events sequence. The user records all random events 24 received from the online casino. It is understood that the user may record the random events manually, as a function of the client game software or other well know methods for recording. Once the number of random events in the pre-generated sequence have been exhausted or the user indicates an intent to terminate the game session, the online casino communicates a “Game is Over” to the user and the game ends 26.

The online casino then sends the user an encryption key 28 for game verification to prove the integrity of the game. The encryption key allows the user to decode the encrypted random events sequence that was transmitted to the user at the beginning of the game session. The user decodes the encrypted random events sequence 30 and the decoded random events sequence is compared to the record 32 the user kept of the random events sequence sent by the online casino at the commencement of the game session. It is understood that the user may compare the record the random events manually, as a function of the client game software or other well know methods for recording. If the sequences are identical, then the game was fair 34 and the random events sequence was not altered or tampered with during the game session. If the verification fails, the user communicates the failure to the online casino and an appropriate action is taken.

As shown in FIG. 2, the online casino may also encode the pre-generated random events sequence using a digital digest at the encoding step. The online casino converts the random events sequence into the digital digest 36 before transmitting the digital digest to the user 38. The specified game is played 22. The user records the random events 24 during the game session. Once the game ends 26, the online casino sends the user an undigested random events sequence 40. The user then verifies the authenticity of the random events sequence 42 sent by the online casino by converting the undigested random events sequence into the digital digest, and comparing this digital digest with the digital digest sent by the casino at the commencement of the game. For the verification to succeed, the two digital digests should be identical. Once the random events sequence sent by the online casino is thus verified, the user proceeds with verifying the random events sequence 44 sent by the online casino during the game session by comparing the verified undigested random events sequence sent by the casino at the end of the game with the random events sequences kept by the user. For the verification to succeed, the two random events sequences must be identical. Similarly, the comparison can be carried out by the user manually or by the client software. If the sequences are identical, then the game was fair 46 and the random events sequence was not altered or tampered with during the game session. If the verification fails, the user communicates the failure to the online casino and an appropriate action is taken.

Referring to FIG. 3, the online casino may also encode the pre-generated random events sequence by first encrypting and then converting the encoded sequence into a digital digest to complete the encoding step. The online casino encrypts the random events sequence and then converts it into the digital digest 48 before transmitting it to the user 50. The specified game is played 22. The user records the random events 24 during the game session. Once the game ends 26, the online casino transmits to the user an undigested random events sequence in its encrypted form. The online casino also transmits to the user an encryption key 52. The user first authenticates the encrypted random events sequence by converting it into a digital digest, and then comparing it to the digital digest 54 sent at the commencement of the game session. The random events sequence is then decoded 56 and compared to the record the user kept of the random events sequence sent by the online casino 58. The user may carry out the comparison manually or by the client game software. For the verification to succeed, the sequences must be identical. If the sequences are identical, then the game was fair 60 and the random events sequence was not altered or tampered with during the game session. If the verification fails, the user communicates the failure to the online casino and an appropriate action is taken.

Using the above method, the user may be confident that the random events sequence was generated without fraudulent action or knowledge of the online casino since the encrypted sequence was pre-generated and sent to the user prior to beginning of the game session, eliminating any chance for the online casino to modify the sequence of events, and thus the game, in response to the user's actions or steps during the game session.

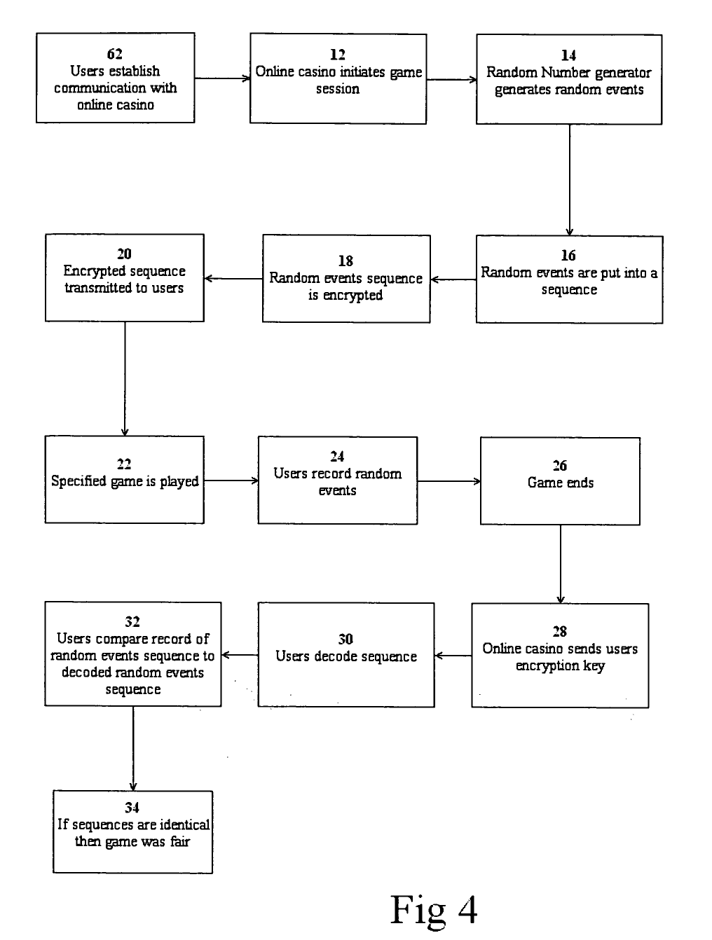

Referring to FIG. 4, the game session may be played with more than one user 62. The online casino may send the same encrypted sequence, which is pre-generated, to each participant (i.e. the encrypted sequence represents the same deck of cards). Each user must have access to the sequence of random events received by other users during the game session. At the end of the game session, the users then collectively compare the sequence of random events received to the sequence of random events that the online casino transmitted at the beginning of the game session to ensure that the sequence was not altered.

Although the present invention is shown in FIGS. 1 to 4 with the method for ensuring the authenticity and integrity of online games described above, it is understood and within the scope of the present invention that the features of the present invention may be used with any electronic game or technology requiring authentication of a random events sequence. Thus, the present invention is not limited to the features and embodiments described above.

1. A method for ensuring the authenticity and integrity of a random events sequence used in an online game, comprising the steps of:
generating a sequence of random events;
encoding said sequence of random events to generate an encoded sequence of random events;
transmitting said encoded sequence of random events to a user;
commencing a game consuming events from said sequence of random events;
sending an encryption key to said user; and
decoding said encoded sequence of random events so that said user may verify integrity of said online game.

2. The method of claim 1, wherein a number of events in said sequence of random events is determined by the type of game played.

3. The method of claim 1, wherein said user records said sequence of random events during said game.

4. The method of claim 1, wherein said online casino game is played with more than one user.

5. A method for ensuring the authenticity and integrity of random events used in an online game, comprising the steps of:
requesting initiation of a game session by a user from said online casino;
generating a sequence of random events by a random number generator;
encoding said sequence of random events by said online casino;
commencing a game consuming events from said sequence of random events;
sending an encryption key to said user;
decoding said encoded sequence of random events using said encryption key by said user; and
verifying the online game by comparing said encoded sequence of random events to said encryption key.

6. The method of claim 5, wherein said user records said sequence of random events during said game.

7. The method of claim 5, wherein a number of events in said sequence of random events is determined by the type of game played.

8. The method of claim 5, wherein the step of encoding said sequence of random events includes creating a digital digest.

9. The method of claim 5, wherein said online casino game is played with more than one user.

10. A method for ensuring the authenticity and integrity of random events used in an online game, comprising the steps of:
requesting initiation of a game session by a user from said online casino;
generating a sequence of random events by a random number generator;
encoding said sequence of random events by said online casino and transmitting to said user;
commencing a game using as input events from said sequence of random events; and
authenticating the game.

11. The method of claim 10, wherein said step of encoding comprises encrypting said sequence of random events.

12. The method of claim 11, wherein said user records said random events sequence during said game.

13. The method of claim 12, wherein the step of authenticating the game comprises sending an encryption key to said user, decoding said sequence of random events, comparing said recorded sequence of random events to said sequence of events decoded.

14. The method of claim 13, wherein said step of encoding comprises creating a digital digest of said sequence of random events.

15. The method of claim 14, wherein said user records said random events sequence during said game.

16. The method of claim 15, wherein the step of authenticating the game comprises sending an undigested random events sequence to said user, verifying said sequence of random events, comparing said sequence of random events which are recorded to said sequence of random events which are verified.

17. The method of claim 16, wherein said step of encoding comprises encrypting said sequence of random events and converting said sequence of random events to a digital digest.

18. The method of claim 17, wherein said user records said random events during said game.

19. The method of claim 18, wherein the step of authenticating the game comprises sending an undigested encrypted random events sequence and encryption key to said user, verifying said encrypted sequence of random events, decoding said sequence of random events and comparing said sequence of random events which are recorded to said sequence of random events which are verified.

20. A method for ensuring the integrity of a sequence of random events comprising the steps of:
encoding a sequence of random events;
transmitting the encoded sequence of random events to at least one user of a process employing at least a portion of the random events; and
upon completion of the process, transmitting to the at least one user a key enabling the user to decode the encoded sequence of random events.

21. The method according to claim 20, wherein the process is a computerized gaming operation.

22. The method according to claim 20, further comprising receiving from the at least one user a comparison of the decoded sequence of random events and the employed portion of the random events.

23. The method according to claim 20, wherein a number of random events in the sequence of random events is determined as a function of the process.

24. The method according to claim 20, wherein the encoding of the sequence of random events comprises encrypting the sequence of random events and wherein the key is a decryption key.

25. The method according to claim 20, wherein the encoded sequence of random events is a digital digest of the sequence of random events and the key is an undigested version of the sequence of random events.

26. The method according to claim 25, wherein the key enables the at least one user to digest the undigested version of the sequence of random events for comparison with the digital digest of the sequence of random events.

27. The method according to claim 20, wherein encoding the sequence of random events comprises encrypting the sequence of random events to create an encrypted sequence of random events, further comprising the step of creating a digital digest of the encrypted sequence of random events.

28. The method according to claim 27, wherein the key enables the at least one user to digest an undigested version of the encrypted sequence of random events and to decrypt the undigested version of the encrypted sequence of random events.

29. The method according to claim 20, wherein encoding the sequence of random events comprises creating a digital digest of the sequence of random events and encrypting the digital digest.

30. The method according to claim 29, wherein the key enables the at least one user to decrypt the digital digest and digest an undigested version of the sequence of random events.

31. A method for ensuring the integrity of a computerized gaming operation, comprising the steps of:
generating, upon receipt of a request from at least one user to initiate a game, a sequence of random events to be used in the game;
encoding the sequence of random events;
transmitting the encoded sequence of random events to the at least one user;
after transmission of the encoded sequence of events to the at least one user, running the game using the sequence of random events; and
after completion of the game, transmitting to the user a key enabling the at least one user to decode the encoded sequence of random events.

32. The method according to claim 31, further comprising receiving, from the at least one user a comparison of the decoded sequence of random events and at least a portion of the random events employed in the game.

33. The method according to claim 32, wherein a number of random events in the sequence of random events is determined as a function of the game.

34. The method according to claim 31, wherein the encoded sequence of random events is an encrypted version of the sequence of random events and the key is a decryption key.

35. The method according to claim 31, wherein the encoded sequence of random events is a digital digest of the sequence of random events and the key is an undigested version of the sequence of random events.

36. The method according to claim 35, wherein the key enables the at least one user to digest the undigested version of the sequence of random events for comparison with the digital digest of the sequence of random events.

37. The method according to claim 31, wherein encoding the sequence of random events comprises encrypting the sequence of random events to create an encrypted sequence of random events and creating a digital digest of the encrypted sequence of random events.

38. The method according to claim 37, wherein the key enables the at least one user to digest an undigested version of the encrypted sequence of random events and to decrypt the undigested version of the encrypted sequence of random events.

39. The method according to claim 31, wherein encoding the sequence of random events comprises creating a digital digest of the sequence of random events and encrypting the digital digest.

40. The method according to claim 39, wherein the key enables the at least one user to decrypt the digital digest and to digest an undigested version of the sequence of random events.
